(19) United States
(12) Patent Application Publication
(10) Pub. No.: US 2024/0054789 A1
(43) Pub. Date: Feb. 15, 2024

(54) DRONE DATA COLLECTION OPTIMIZATION FOR EVIDENCE RECORDING

(71) Applicant: FARO Technologies, Inc., Lake Mary, FL (US)

(72) Inventor: Tharesh Sharma, Waiblingen (DE)

(21) Appl. No.: 18/356,850

(22) Filed: Jul. 21, 2023

Related U.S. Application Data
(60) Provisional application No. 63/396,282, filed on Aug. 9, 2022.

(51) Int. Cl. G06V 20/52; G06V 20/17; G06V 10/82

(52) U.S. Cl. CPC G06V 20/52; G06V 20/17; G06V 10/82; G06V 2201/121

(57) ABSTRACT

A computer-implemented method is provided that includes causing an aerial vehicle to scan an environment in a predesignated pattern, such that a first set of images are captured. The method further includes detecting an emergency scene in the first set of images of the environment. The method further includes determining locations at which the aerial vehicle is to capture a second set of images of the emergency scene in the environment. The method further includes causing the aerial vehicle to acquire the second set of images at the locations. The method further includes determining selected images of the second set of images focused on the emergency scene. The method further includes extracting the selected images from the second set of images, the selected images comprising a representation of the emergency scene.

### CROSS-REFERENCE OF RELATED APPLICATIONS

This application claims the benefit of U.S. Provisional Patent Application Ser. No. 63/396,282, filed Aug. 8, 2022, and entitled “DRONE DATA COLLECTION OPTIMIZATION FOR EVIDENCE RECORDING,” the contents of which are incorporated by reference herein in its entirety.

### BACKGROUND

The subject matter described herein relates generally to drone data collection optimization for evidence recording, and more specifically, to automatically collecting evidence at a crash scene.

The points in a three-dimensional (3D) point cloud, such as that generated by a 3D laser scanner time-of-flight (TOF) coordinate measurement device or created by algorithms that takes data from photogrammetry, are very useful. A 3D TOF laser scanner of this type steers a beam of light to a non-cooperative target such as a diffusely scattering surface of an object. A distance meter in the device measures a distance to the object, and angular encoders measure the angles of rotation of two axles in the device. The measured distance and two angles enable a processor in the device to determine the 3D coordinates of the target.

A TOF laser scanner is a scanner in which the distance to a target point is determined based on the speed of light in air between the scanner and a target point. Laser scanners are typically used for scanning closed or open spaces such as interior areas of buildings, industrial installations and tunnels. They may be used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected, stored and sent to a processor or processors to generate a 3D image representing the scanned area or object.

Generating an image requires at least three values for each data point. These three values may include the distance and two angles, or may be transformed values, such as the x, y, z coordinates. In an embodiment, an image is also based on a fourth gray-scale value, which is a value related to irradiance of scattered light returning to the scanner.

Most TOF scanners direct the beam of light within the measurement volume by steering the light with a beam steering mechanism. The beam steering mechanism includes a first motor that steers the beam of light about a first axis by a first angle that is measured by a first angular encoder (or other angle transducer). The beam steering mechanism also includes a second motor that steers the beam of light about a second axis by a second angle that is measured by a second angular encoder (or other angle transducer).

Many contemporary laser scanners include a camera mounted on the laser scanner for gathering camera digital images of the environment and for presenting the camera digital images to an operator of the laser scanner. By viewing the camera images, the operator of the scanner can determine the field of view of the measured volume and adjust settings on the laser scanner to measure over a larger or smaller region of space. In addition, the camera digital images may be transmitted to a processor to add color to the scanner image. To generate a color scanner image, at least three positional coordinates (such as x, y, z) and three color values (such as red, green, blue “RGB”) are collected for each data point.

A 3D point cloud of data points is formed by the set of three positional coordinates (such as x, y, z) and three color values (such as red, green, blue “RGB”). Processing is generally performed on the 3D point cloud of data points which can include millions of data points. However, additional software processing tools for 3D data points in a 3D point cloud can be helpful to a user.

Accordingly, while existing image collection are suitable for their intended purposes, what is needed image collection techniques having certain features of embodiments disclosed herein.

### BRIEF DESCRIPTION

According to one embodiment, a computer-implemented method for drone data collection optimization for evidence recording is provided. The method includes causing an aerial vehicle to scan an environment in a predesignated pattern, such that a first set of images are captured, detecting an emergency scene in the first set of images of the environment, and determining locations at which the aerial vehicle is to capture a second set of images of the emergency scene in the environment. The method includes causing the aerial vehicle to acquire the second set of images at the locations, determining selected images of the second set of images focused on the emergency scene, and extracting the selected images from the second set of images, the selected images comprising a representation of the emergency scene.

In addition to one or more features described herein, or as an alternative, further embodiments of the method may include wherein the second set of images comprises a higher resolution than the first set of images.

In addition to one or more features described herein, or as an alternative, further embodiments of the method may include wherein the locations form a geographical area less than the predesignated pattern such that the locations are narrowed to a view of the emergency scene.

In addition to one or more features described herein, or as an alternative, further embodiments of the method may include wherein a machine learning model is used to detect the emergency scene in the first set of images of the environment, the machine learning model is trained to detect objects associated with the emergency scene in the first set of images and infer that the emergency scene is present in the environment.

In addition to one or more features described herein, or as an alternative, further embodiments of the method may include wherein: coordinates of a geographical area comprising the emergency scene are determined; and determining the locations at which the aerial vehicle is to capture the second set of images of the emergency scene in the environment comprises using one or more of the coordinates as the locations at which to capture the second set of images.

In addition to one or more features described herein, or as an alternative, further embodiments of the method may include wherein a machine learning model is trained to determine the selected images of the second set of images focused on the emergency scene.

In addition to one or more features described herein, or as an alternative, further embodiments of the method may include wherein the machine learning model is configured to find objects in the selected images that are associated with the reconstruction of an emergency of the emergency scene.

In addition to one or more features described herein, or as an alternative, further embodiments of the method may include wherein the emergency scene is a crash scene.

In addition to one or more features described herein, or as an alternative, further embodiments of the method may include wherein the locations are transmitted to the aerial vehicle at which to acquire the second set of images at the locations.

According to an embodiment, a system is provided. The system includes a memory having computer readable instructions and one or more processors for executing the computer readable instructions. The computer readable instructions control the one or more processors to perform operations. The operations include causing an aerial vehicle to scan an environment in a predesignated pattern, such that a first set of images are captured. The operations further include detecting an emergency scene in the first set of images of the environment. The operations further include determining locations at which the aerial vehicle is to capture a second set of images of the emergency scene in the environment. The operations further include causing the aerial vehicle to acquire the second set of images at the locations. The operations further include determining selected images of the second set of images focused on the emergency scene. The operations further include extracting the selected images from the second set of images, the selected images comprising a representation of the emergency scene.

In addition to one or more features described herein, or as an alternative, further embodiments of the system may include that the second set of images comprises a higher resolution than the first set of images.

In addition to one or more features described herein, or as an alternative, further embodiments of the system may include that the locations form a geographical area less than the predesignated pattern such that the locations are narrowed to a view of the emergency scene.

In addition to one or more features described herein, or as an alternative, further embodiments of the system may include that a machine learning model is used to detect the emergency scene in the first set of images of the environment, the machine learning model is trained to detect objects associated with the emergency scene in the first set of images and infer that the emergency scene is present in the environment.

In addition to one or more features described herein, or as an alternative, further embodiments of the system may include that: coordinates of a geographical area comprising the emergency scene are determined; and determining the locations at which the aerial vehicle is to capture the second set of images of the emergency scene in the environment comprises using one or more of the coordinates as the locations at which to capture the second set of images.

In addition to one or more features described herein, or as an alternative, further embodiments of the system may include that a machine learning model is trained to determine the selected images of the second set of images focused on the emergency scene.

In addition to one or more features described herein, or as an alternative, further embodiments of the system may include that the machine learning model is configured to find objects in the selected images that are associated with a reconstruction of an emergency of the emergency scene.

In addition to one or more features described herein, or as an alternative, further embodiments of the system may include that the emergency scene is an accident scene.

In addition to one or more features described herein, or as an alternative, further embodiments of the system may include that the locations are transmitted to the aerial vehicle at which to acquire the second set of images at the locations.

According to an embodiment, a computer program product is provided. The computer program product includes a computer readable storage medium having program instructions embodied therewith, the program instructions executable by one or more processors to cause the one or more processors to perform operations. The operations include causing an aerial vehicle to scan an environment in a predesignated pattern, such that a first set of images are captured. The operations further include detecting an emergency scene in the first set of images of the environment. The operations further include determining locations at which the aerial vehicle is to capture a second set of images of the emergency scene in the environment. The operations further include causing the aerial vehicle to acquire the second set of images at the locations. The operations further include determining selected images of the second set of images focused on the emergency scene. The operations further include extracting the selected images from the second set of images, the selected images comprising a representation of the emergency scene.

In addition to one or more features described herein, or as an alternative, further embodiments of the computer program product may include that the second set of images comprises a higher resolution than the first set of images.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram of an example drone according to one or more embodiments;

FIG. 2A is a perspective view of a laser scanner in accordance with an embodiment;

FIG. 2B is a side view of the laser scanner illustrating a method of measurement according to an embodiment;

FIG. 3 is a schematic illustration of the optical, mechanical, and electrical components of the laser scanner according to an embodiment;

FIG. 4 illustrates a schematic illustration of the laser scanner of FIG. 2A according to an embodiment;

FIG. 5 is a block diagram of an example computer system for use in conjunction with one or more embodiments;

FIG. 6 is a block diagram of a computer system for automatic drone data collection optimization for evidence recording of an emergency scene according to one or more embodiments;

FIG. 7 illustrates an emergency scene in an environment according to one or more embodiments;

FIG. 8 is a flowchart for automatic drone data collection of an emergency scene according to one or more embodiments;

FIG. 9 illustrates an example geographical area encompassing the emergency scene according to one or more embodiments;

FIG. 10 illustrates automatically capturing images of the emergency scene in a geometric area according to one or more embodiments; and

FIG. 11 is a flowchart of a computer-implemented method for drone data collection optimization for evidence recording at an emergency scene according to one or more embodiments.

The detailed description explains embodiments of the invention, together with advantages and features, by way of example with reference to the drawings.

### DETAILED DESCRIPTION

One or more embodiments described herein relate to drone data collection optimization for evidence recording, and to automatically collecting evidence at a crash scene. unmanned aerial vehicles (UAVs) and remotely piloted aircraft (RPA), commonly referred to as “drones,” are quickly becoming essential to public safety professionals who work with crash scene reconstruction. Drones have been used to provide fast capture of crash scenes and provide advantages when compared to older methods of data collection. Safety professionals, including the police, can use automatic drone data collection for a crash scene, as disclosed in one or more embodiments. This can assist the police with making determinations during crash scene reconstruction along with providing the supported documentation. According to one or more embodiments, initially, as a drone performs an automatic capture detection routine, the drone can be configured (e.g., instructed) to perform a scene identification process. During scene identification, the drone records some images temporarily. These temporary images are not stored. In one or more embodiments, the temporary images may be stored for a brief period of time. During automatic pose estimation, the temporary images captured during scene identification are used (only) for calculating the poses, which are locations for the drone to capture subsequent images. Particularly, the images obtained in the scene identification process are used to determine the best possible or desired poses for subsequently recording the data/images. Accordingly, the drone flies to the locations and records data/images based on the best possible drone poses. Only these recorded data/images are stored and made available for the officer as evidence.

Technical effects and benefits of one or more embodiments include the efficient and automatic detection of emergency scenes using a drone followed by automatic drone data collection for the emergency scene, which can be utilized by public safety professionals (i.e., emergency personnel including police officers, emergency rescue personnel, paramedics, etc.). The collected images may utilized in photogrammetry, for 3D point cloud creation, search and rescue, accident reconstruction, report generation, etc.

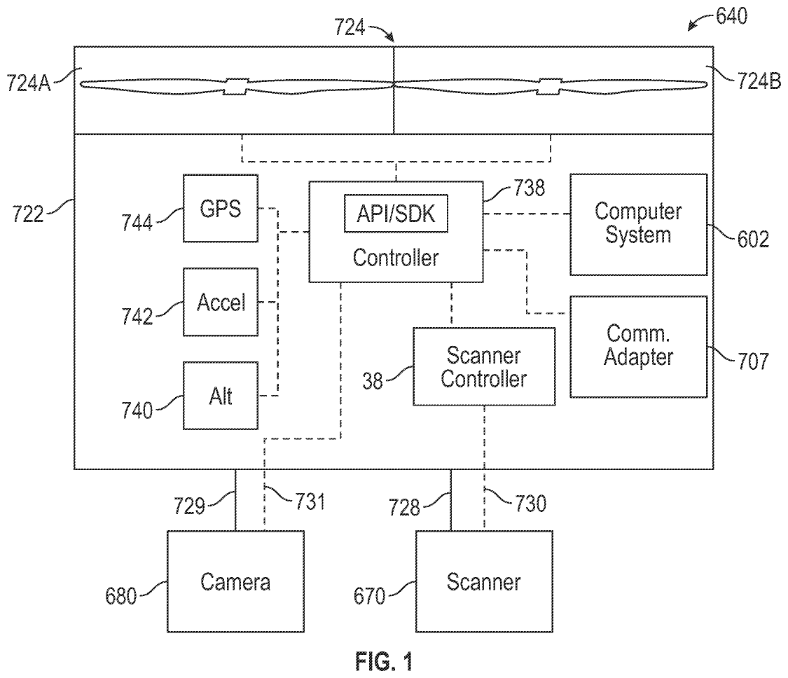

Referring now to FIG. 1, an example drone 640 is depicted, which is used to perform a predetermined function, such as scan an object or environment for example. The drone 640 includes a fuselage 722 that supports at least one thrust device 724. In an embodiment, the drone 640 includes a plurality of thrust devices 724A, 724B, such as four thrust devices arranged about the periphery of the fuselage 722. In an embodiment, the thrust devices 724 include a propeller member that rotates to produce thrust. The thrust devices 724 may be configurable to provide both lift (vertical thrust) and lateral thrust (horizontal thrust). The vertical and horizontal components of the thrust allow the changing of the altitude, lateral movement, and orientation (attitude) of the drone 640.

In the exemplary embodiment, the fuselage 722 and thrust devices 724 are sized and configured to carry a payload such as an optical scanner 670 that is configured to measure three-dimensional coordinates of points in the environment or on an object. Particularly, the drone 640 can carry the camera 680 and/or the scanner 670. The scanner 670 may be a time-of-flight scanner, a triangulation scanner, an area scanner, a structured light scanner, or a laser tracker for example. In an embodiment, the scanner 670 may be releasably coupled to the fuselage 722 by a coupling 728. The camera 680 may be releasably coupled to the fuselage 722 by a coupling 729.

In another embodiment, the scanner 20 may be integral with or fixedly coupled to the fuselage 722. As will be discussed in more detail herein, the scanner 670 may also be coupled to a scanner controller 38 by a communication and power connection 730. Similarly, the camera 680 may be coupled to the controller 738 by a communication and power connection 731. It should be appreciated that the scanner controller 38 may be located in the scanner 670, within the fuselage 722, or include multiple processing units that are distributed between the scanner 670, the fuselage 722, or are remotely located from the drone 640. The scanner controller 38 may be coupled to communicate with a drone controller 738.

Both the drone controller 738 and the scanner controller 38 may include processors that are responsive to operation control methods embodied in application code. These methods are embodied in computer instructions written to be executed by the processor, such as in the form of software. The controller 738 is coupled to the thrust devices 724 and configured to transmit and receive signals from the thrust devices 724. The controller 738 may further be coupled to one or more sensor devices that enable to the controller to determine the position, orientation, and altitude of the drone 640. In an embodiment, these sensors may include an altimeter 740, a gyroscope or accelerometers 742 or a global positioning satellite (GPS) system 744. In other embodiments, the controller 738 may be coupled to other sensors, such as force sensors. The drone controller 738 may be coupled to a communication adapter 707 to transmit and receive signals from the computer system 602 over the network 650, such that the drone controller 738 can execute instructions/commands from the computer system 602. Also, the drone controller 738 can send images to the computer system 602.

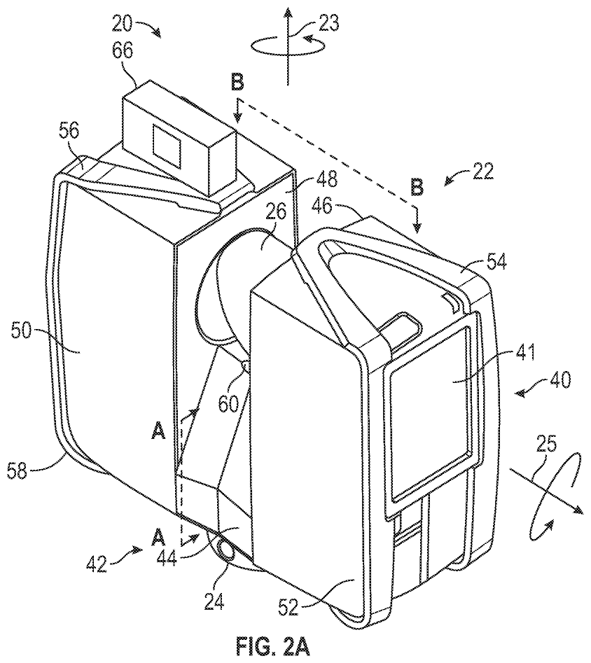

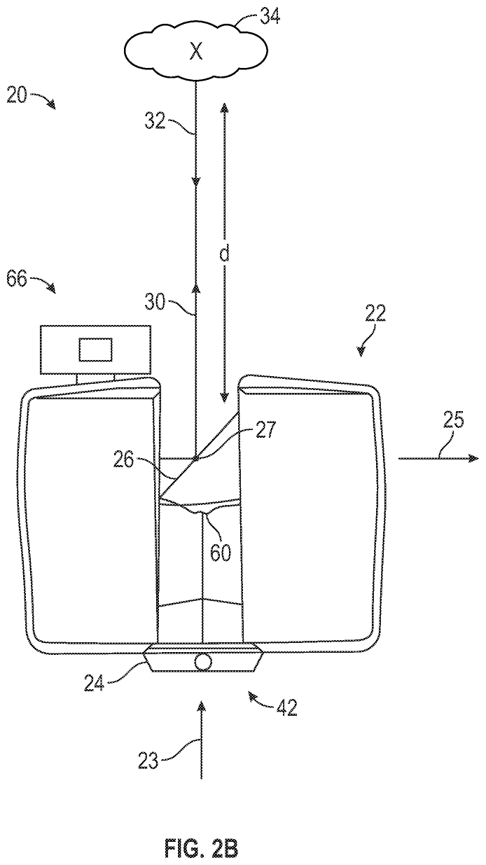

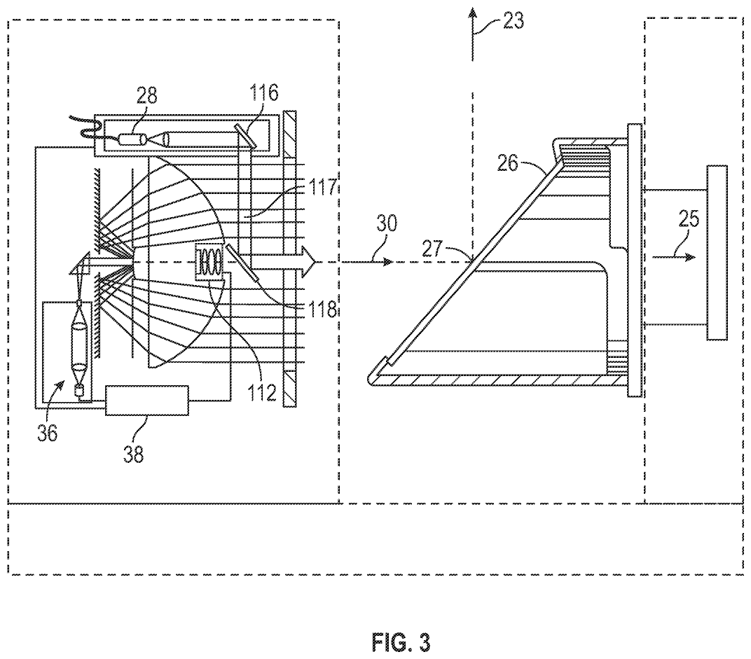

Referring now to FIGS. 2A, 2B, and 3, a coordinate measurement device, such as a laser scanner 20, is shown for optically scanning and measuring the environment surrounding the laser scanner 20. The laser scanner 20 has a measuring head 22 and a base 24. The measuring head 22 is mounted on the base 24 such that the laser scanner 20 may be rotated about a vertical axis 23. In one embodiment, the measuring head 22 includes a gimbal point 27 that is a center of rotation about the vertical axis 23 and a horizontal axis 25. The measuring head 22 has a rotary mirror 26, which may be rotated about the horizontal axis 25. The rotation about the vertical axis may be about the center of the base 24. The terms vertical axis and horizontal axis refer to the scanner in its normal upright position. It is possible to operate a 3D coordinate measurement device on its side or upside down, and so to avoid confusion, the terms azimuth axis and zenith axis may be substituted for the terms vertical axis and horizontal axis, respectively. The term pan axis or standing axis may also be used as an alternative to vertical axis.

The measuring head 22 is further provided with an electromagnetic radiation emitter, such as light emitter 28, for example, that emits an emitted light beam 30. In one embodiment, the emitted light beam 30 is a coherent light beam such as a laser beam. The laser beam may have a wavelength range of approximately 300 to 1600 nanometers, for example 790 nanometers, 905 nanometers, 1550 nm, or less than 400 nanometers. It should be appreciated that other electromagnetic radiation beams having greater or smaller wavelengths may also be used. The emitted light beam 30 is amplitude or intensity modulated, for example, with a sinusoidal waveform or with a rectangular waveform. The emitted light beam 30 is emitted by the light emitter 28 onto a beam steering unit, such as mirror 26, where it is deflected to the environment. A reflected light beam 32 is reflected from the environment by an object 34. The reflected or scattered light is intercepted by the rotary minor 26 and directed into a light receiver 36. The directions of the emitted light beam 30 and the reflected light beam 32 result from the angular positions of the rotary mirror 26 and the measuring head 22 about the axes 25 and 23, respectively. These angular positions in turn depend on the corresponding rotary drives or motors.

Coupled to the light emitter 28 and the light receiver 36 is a controller 38. The controller 38 determines, for a multitude of measuring points X, a corresponding number of distances d between the laser scanner 20 and the points X on object 34. The distance to a particular point X is determined based at least in part on the speed of light in air through which electromagnetic radiation propagates from the device to the object point X. In one embodiment the phase shift of modulation in light emitted by the laser scanner 20 and the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, cₐᵢᵣ=c/n. A laser scanner of the type discussed herein is based on the time-of-flight (TOF) of the light in the air (the round-trip time for the light to travel from the device to the object and back to the device). Examples of TOF scanners include scanners that measure round trip time using the time interval between emitted and returning pulses (pulsed TOF scanners), scanners that modulate light sinusoidally and measure phase shift of the returning light (phase-based scanners), as well as many other types. A method of measuring distance based on the time-of-flight of light depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based on one known length and two known angles of a triangle. The method of triangulation, therefore, does not directly depend on the speed of light in air.

In one mode of operation, the scanning of the volume around the laser scanner 20 takes place by rotating the rotary mirror 26 relatively quickly about axis 25 while rotating the measuring head 22 relatively slowly about axis 23, thereby moving the assembly in a spiral pattern. In an exemplary embodiment, the rotary mirror rotates at a maximum speed of 5820 revolutions per minute. For such a scan, the gimbal point 27 defines the origin of the local stationary reference system. The base 24 rests in this local stationary reference system.

In addition to measuring a distance d from the gimbal point 27 to an object point X, the scanner 20 may also collect gray-scale information related to the received optical power (equivalent to the term “brightness.”) The gray-scale value may be determined at least in part, for example, by integration of the bandpass-filtered and amplified signal in the light receiver 36 over a measuring period attributed to the object point X.

The measuring head 22 may include a display device 40 integrated into the laser scanner 20. The display device 40 may include a graphical touch screen 41, as shown in FIG. 2A, which allows the operator to set the parameters or initiate the operation of the laser scanner 20. For example, the screen 41 may have a user interface that allows the operator to provide measurement instructions to the device, and the screen may also display measurement results.

The laser scanner 20 includes a carrying structure 42 that provides a frame for the measuring head 22 and a platform for attaching the components of the laser scanner 20. In one embodiment, the carrying structure 42 is made from a metal such as aluminum. The carrying structure 42 includes a traverse member 44 having a pair of walls 46, 48 on opposing ends. The walls 46, 48 are parallel to each other and extend in a direction opposite the base 24. Shells 50, 52 are coupled to the walls 46, 48 and cover the components of the laser scanner 20. In the exemplary embodiment, the shells 50, 52 are made from a plastic material, such as polycarbonate or polyethylene for example. The shells 50, 52 cooperate with the walls 46, 48 to form a housing for the laser scanner 20.

On an end of the shells 50, 52 opposite the walls 46, 48 a pair of yokes 54, 56 are arranged to partially cover the respective shells 50, 52. In the exemplary embodiment, the yokes 54, 56 are made from a suitably durable material, such as aluminum for example, that assists in protecting the shells 50, 52 during transport and operation. The yokes 54, 56 each includes a first arm portion 58 that is coupled, such as with a fastener for example, to the traverse 44 adjacent the base 24. The arm portion 58 for each yoke 54, 56 extends from the traverse 44 obliquely to an outer corner of the respective shell 50, 52. From the outer corner of the shell, the yokes 54, 56 extend along the side edge of the shell to an opposite outer corner of the shell. Each yoke 54, 56 further includes a second arm portion that extends obliquely to the walls 46, 48. It should be appreciated that the yokes 54, 56 may be coupled to the traverse 42, the walls 46, 48 and the shells 50, 54 at multiple locations.

The pair of yokes 54, 56 cooperate to circumscribe a convex space within which the two shells 50, 52 are arranged. In the exemplary embodiment, the yokes 54, 56 cooperate to cover all of the outer edges of the shells 50, 54, while the top and bottom arm portions project over at least a portion of the top and bottom edges of the shells 50, 52. This provides advantages in protecting the shells 50, 52 and the measuring head 22 from damage during transportation and operation. In other embodiments, the yokes 54, 56 may include additional features, such as handles to facilitate the carrying of the laser scanner 20 or attachment points for accessories for example.

On top of the traverse 44, a prism 60 is provided. The prism extends parallel to the walls 46, 48. In the exemplary embodiment, the prism 60 is integrally formed as part of the carrying structure 42. In other embodiments, the prism 60 is a separate component that is coupled to the traverse 44. When the mirror 26 rotates, during each rotation the mirror 26 directs the emitted light beam 30 onto the traverse 44 and the prism 60. Due to non-linearities in the electronic components, for example in the light receiver 36, the measured distances d may depend on signal strength, which may be measured in optical power entering the scanner or optical power entering optical detectors within the light receiver 36, for example. In an embodiment, a distance correction is stored in the scanner as a function (possibly a nonlinear function) of distance to a measured point and optical power (generally unscaled quantity of light power sometimes referred to as “brightness”) returned from the measured point and sent to an optical detector in the light receiver 36. Since the prism 60 is at a known distance from the gimbal point 27, the measured optical power level of light reflected by the prism 60 may be used to correct distance measurements for other measured points, thereby allowing for compensation to correct for the effects of environmental variables such as temperature. In the exemplary embodiment, the resulting correction of distance is performed by the controller 38.

In an embodiment, the base 24 is coupled to a swivel assembly (not shown) such as that described in commonly owned U.S. Pat. No. 8,705,012 (′012), which is incorporated by reference herein. The swivel assembly is housed within the carrying structure 42 and includes a motor 138 that is configured to rotate the measuring head 22 about the axis 23. In an embodiment, the angular/rotational position of the measuring head 22 about the axis 23 is measured by angular encoder 134.

An auxiliary image acquisition device 66 may be a device that captures and measures a parameter associated with the scanned area or the scanned object and provides a signal representing the measured quantities over an image acquisition area. The auxiliary image acquisition device 66 may be, but is not limited to, a pyrometer, a thermal imager, an ionizing radiation detector, or a millimeter-wave detector. In an embodiment, the auxiliary image acquisition device 66 is a color camera.

In an embodiment, a central color camera (first image acquisition device) 112 is located internally to the scanner and may have the same optical axis as the 3D scanner device. In this embodiment, the first image acquisition device 112 is integrated into the measuring head 22 and arranged to acquire images along the same optical pathway as emitted light beam 30 and reflected light beam 32. In this embodiment, the light from the light emitter 28 reflects off a fixed mirror 116 and travels to dichroic beam-splitter 118 that reflects the light 117 from the light emitter 28 onto the rotary mirror 26. In an embodiment, the mirror 26 is rotated by a motor 136 and the angular/rotational position of the mirror is measured by angular encoder 134. The dichroic beam-splitter 118 allows light to pass through at wavelengths different than the wavelength of light 117. For example, the light emitter 28 may be a near infrared laser light (for example, light at wavelengths of 780 nm or 1150 nm), with the dichroic beam-splitter 118 configured to reflect the infrared laser light while allowing visible light (e.g., wavelengths of 400 to 700 nm) to transmit through. In other embodiments, the determination of whether the light passes through the beam-splitter 118 or is reflected depends on the polarization of the light. The digital camera 112 obtains 2D images of the scanned area to capture color data to add to the scanned image. In the case of a built-in color camera having an optical axis coincident with that of the 3D scanning device, the direction of the camera view may be easily obtained by simply adjusting the steering mechanisms of the scanner—for example, by adjusting the azimuth angle about the axis 23 and by steering the mirror 26 about the axis 25.

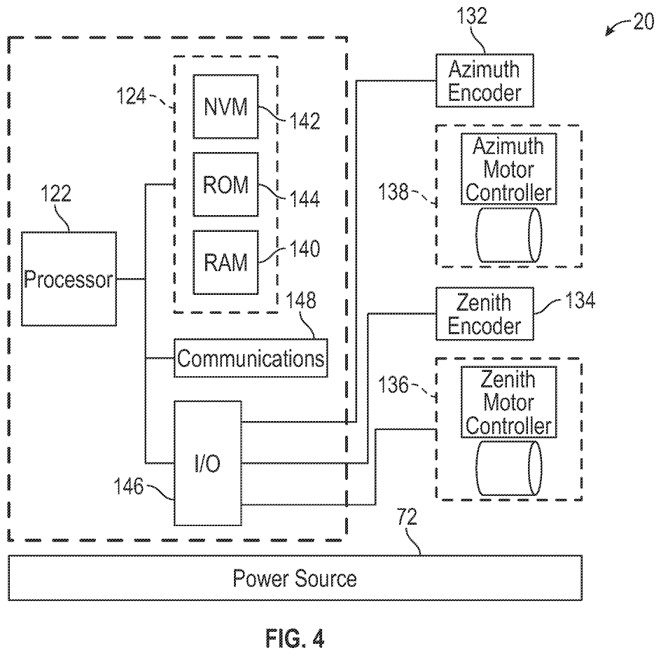

Referring now to FIG. 4 with continuing reference to FIGS. 2A-3, elements are shown of the laser scanner 20. Controller 38 is a suitable electronic device capable of accepting data and instructions, executing the instructions to process the data, and presenting the results. The controller 38 includes one or more processing elements 122. The processors may be microprocessors, field programmable gate arrays (FPGAs), digital signal processors (DSPs), and generally any device capable of performing computing functions. The one or more processors 122 have access to memory 124 for storing information.

Controller 38 is capable of converting the analog voltage or current level provided by light receiver 36 into a digital signal to determine a distance from the laser scanner 20 to an object in the environment. Controller 38 uses the digital signals that act as input to various processes for controlling the laser scanner 20. The digital signals represent one or more laser scanner 20 data including but not limited to distance to an object, images of the environment, images acquired by panoramic camera 126, angular/rotational measurements by a first or azimuth encoder 132, and angular/rotational measurements by a second axis or zenith encoder 134.

In general, controller 38 accepts data from encoders 132, 134, light receiver 36, light source 28, and panoramic camera 126 and is given certain instructions for the purpose of generating a 3D point cloud of a scanned environment. Controller 38 provides operating signals to the light source 28, light receiver 36, panoramic camera 126, zenith motor 136 and azimuth motor 138. The controller 38 compares the operational parameters to predetermined variances and if the predetermined variance is exceeded, generates a signal that alerts an operator to a condition. The data received by the controller 38 may be displayed on a user interface 40 coupled to controller 38. The user interface 40 may be one or more LEDs (light-emitting diodes), an LCD (liquid-crystal diode) display, a CRT (cathode ray tube) display, a touch-screen display or the like. A keypad may also be coupled to the user interface for providing data input to controller 38. In one embodiment, the user interface is arranged or executed on a mobile computing device that is coupled for communication, such as via a wired or wireless communications medium (e.g., Ethernet, serial, USB, Bluetooth™ or WiFi) for example, to the laser scanner 20.

The controller 38 may also be coupled to external computer networks such as a local area network (LAN) and the Internet. A LAN interconnects one or more remote computers, which are configured to communicate with controller 38 using a well-known computer communications protocol such as TCP/IP (Transmission Control Protocol/Internet(\hat{ }) Protocol), RS-232, ModBus, and the like. Additional systems may also be connected to LAN with the controllers 38 in each of these systems being configured to send and receive data to and from remote computers and other systems. The LAN may be connected to the Internet. This connection allows controller 38 to communicate with one or more remote computers connected to the Internet.

The processors 122 are coupled to memory 124. The memory 124 may include random access memory (RAM) device 140, a non-volatile memory (NVM) device 142, and a read-only memory (ROM) device 144. In addition, the processors 122 may be connected to one or more input/output (I/O) controllers 146 and a communications circuit 148. In an embodiment, the communications circuit 148 provides an interface that allows wireless or wired communication with one or more external devices or networks, such as the LAN discussed above.

Controller 38 includes operation control methods embodied in application code. These methods are embodied in computer instructions written to be executed by processors 122, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, C #, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing.

It should be appreciated that while some embodiments herein describe a point cloud that is generated by a TOF scanner, this is for example purposes and the claims should not be so limited. In other embodiments, the point cloud may be generated or created using other types of scanners, such as but not limited to triangulation scanners, area scanners, structured-light scanners, laser line scanners, flying dot scanners, and photogrammetry devices for example.

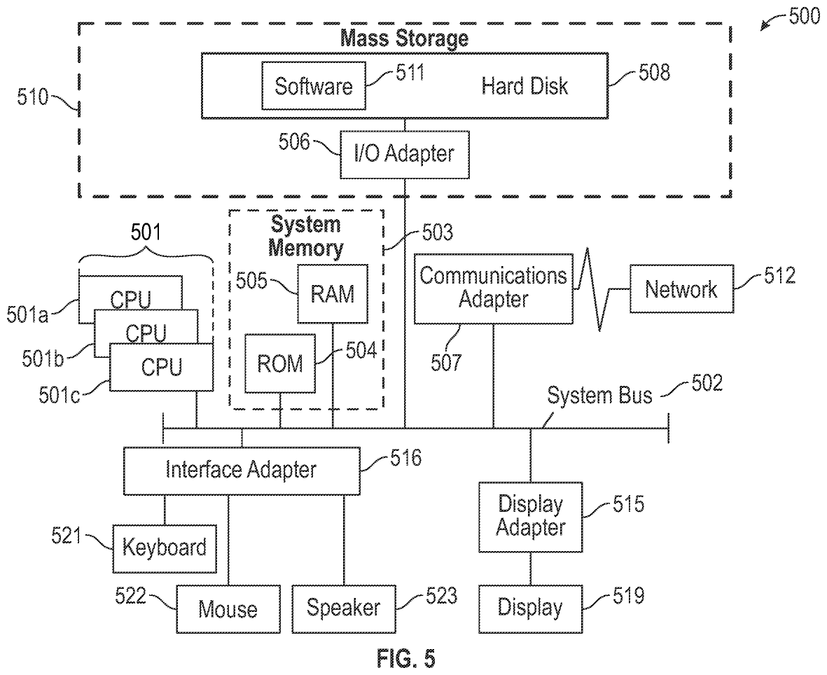

Turning now to FIG. 5, a computer system 500 is generally shown in accordance with one or more embodiments described herein. The computer system 500 can be an electronic, computer framework comprising and/or employing any number and combination of computing devices and networks utilizing various communication technologies, as described herein. The computer system 500 can be easily scalable, extensible, and modular, with the ability to change to different services or reconfigure some features independently of others. The computer system 500 can be, for example, a server, desktop computer, laptop computer, tablet computer, or smartphone. In some examples, computer system 500 can be a cloud computing node. Computer system 500 can be described in the general context of computer system executable instructions, such as program modules, being executed by a computer system. Generally, program modules can include routines, programs, objects, components, logic, data structures, and so on that perform particular tasks or implement particular abstract data types. Computer system 500 can be practiced in distributed cloud computing environments where tasks are performed by remote processing devices that are linked through a communications network. In a distributed cloud computing environment, program modules can be located in both local and remote computer system storage media including memory storage devices.

As shown in FIG. 5, the computer system 500 has one or more central processing units (CPU(s)) 501a, 501b, 501c, etc., (collectively or generically referred to as processor(s) 501). The processors 501 can be a single-core processor, multi-core processor, computing cluster, or any number of other configurations. The processors 501, also referred to as processing circuits, are coupled via a system bus 502 to a system memory 503 and various other components. The system memory 503 can include a read only memory (ROM) 504 and a random access memory (RAM) 505. The ROM 504 is coupled to the system bus 502 and can include a basic input/output system (BIOS) or its successors like Unified Extensible Firmware Interface (UEFI), which controls certain basic functions of the computer system 500. The RAM is read-write memory coupled to the system bus 502 for use by the processors 501. The system memory 503 provides temporary memory space for operations of said instructions during operation. The system memory 503 can include random access memory (RAM), read only memory, flash memory, or any other suitable memory systems.

The computer system 500 comprises an input/output (I/O) adapter 506 and a communications adapter 507 coupled to the system bus 502. The I/O adapter 506 can be a small computer system interface (SCSI) adapter that communicates with a hard disk 508 and/or any other similar component. The I/O adapter 506 and the hard disk 508 are collectively referred to herein as a mass storage 510.

Software 511 for execution on the computer system 500 can be stored in the mass storage 510. The mass storage 510 is an example of a tangible storage medium readable by the processors 501, where the software 511 is stored as instructions for execution by the processors 501 to cause the computer system 500 to operate, such as is described herein below with respect to the various Figures. Examples of computer program product and the execution of such instruction is discussed herein in more detail. The communications adapter 507 interconnects the system bus 502 with a network 512, which can be an outside network, enabling the computer system 500 to communicate with other such systems. In one embodiment, a portion of the system memory 503 and the mass storage 510 collectively store an operating system, which can be any appropriate operating system to coordinate the functions of the various components shown in FIG. 5.

Additional input/output devices are shown as connected to the system bus 502 via a display adapter 515 and an interface adapter 516. In one embodiment, the adapters 506, 507, 515, and 516 can be connected to one or more I/O buses that are connected to the system bus 502 via an intermediate bus bridge (not shown). A display 519 (e.g., a screen or a display monitor) is connected to the system bus 502 by the display adapter 515, which can include a graphics controller to improve the performance of graphics intensive applications and a video controller. A keyboard 521, a mouse 522, a speaker 523, etc., can be interconnected to the system bus 502 via the interface adapter 516, which can include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 5, the computer system 500 includes processing capability in the form of the processors 501, storage capability including the system memory 503 and the mass storage 510, input means such as the keyboard 521 and the mouse 522, and output capability including the speaker 523 and the display 519.

In some embodiments, the communications adapter 507 can transmit data using any suitable interface or protocol, such as the internet small computer system interface, among others. The network 512 can be a cellular network, a radio network, a wide area network (WAN), a local area network (LAN), or the Internet, among others. An external computing device can connect to the computer system 500 through the network 512. In some examples, an external computing device can be an external webserver or a cloud computing node.

It is to be understood that the block diagram of FIG. 5 is not intended to indicate that the computer system 500 is to include all of the components shown in FIG. 5. Rather, the computer system 500 can include any appropriate fewer or additional components not illustrated in FIG. 5 (e.g., additional memory components, embedded controllers, modules, additional network interfaces, etc.). Further, the embodiments described herein with respect to computer system 500 can be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

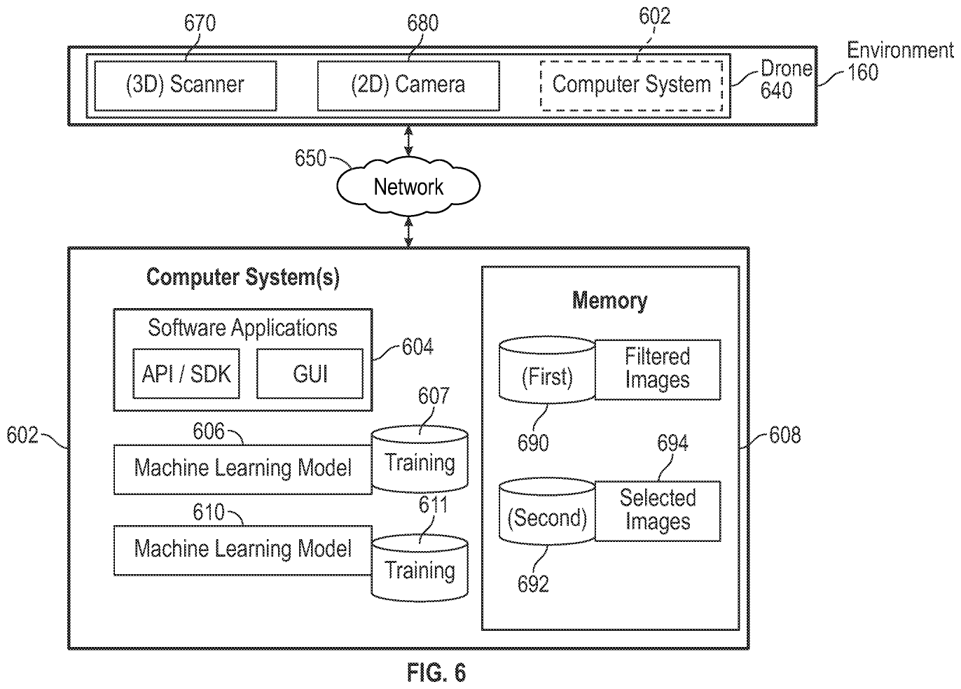

FIG. 6 is a block diagram of a computer system 602 for automatic drone data collection optimization for evidence recording of an emergency scene according to one or more embodiments. Elements of computer system 500 may be used in and/or integrated in computer system 602. A drone 640 is coupled to computer system 602 to receive and transmit data over network 650. In one or more embodiments, the drone 640 may include partial features and/or all the features of computer system 602 as depicted by the dashed box representing one or more features of the computer system 602 in the done 640. The drone 640 may communicate over the network 650 to access features of the computer system 602 and vice versa. The drone 640 can include a scanner 670 such as the laser scanner 20 as discussed in FIGS. 1-4 and/or another suitable three-dimensional coordinate scanning device. Similarly, the drone 640 can include a camera 680, for example, having features of the cameras 66, 112 (of laser scanner 20) and/or another suitable camera.

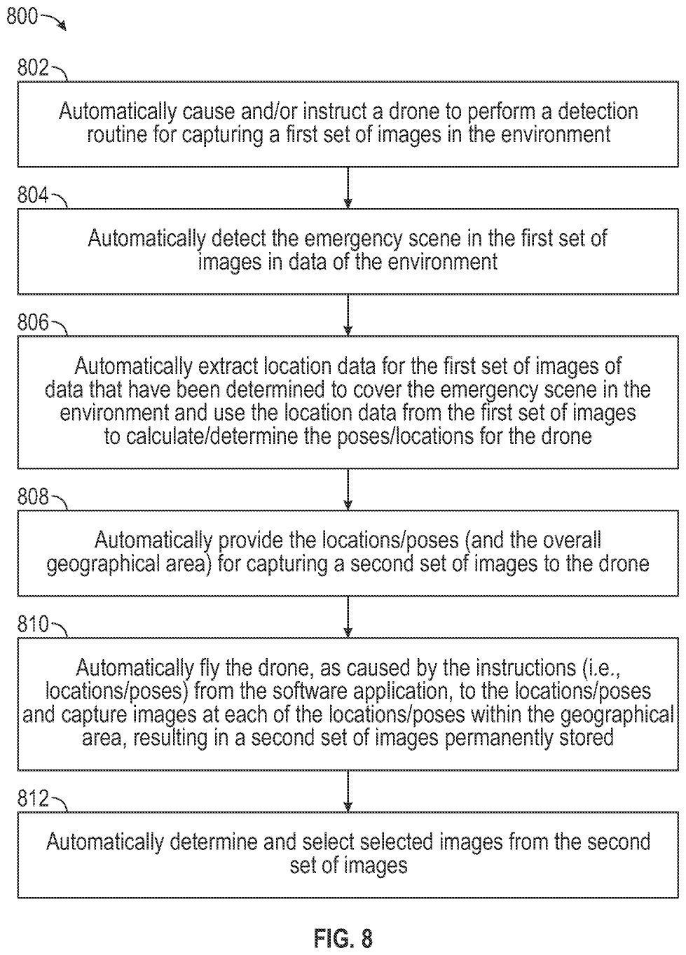

Software application 604 can be used with, integrated in, call, and/or be called by other software applications, such as machine learning model 606, machine learning model 610, photogrammetry software, etc., according to one or more embodiments. In one or more embodiments, software application 604 can be employed by a user for instructing and causing the drone 640 to fly in a predetermined pattern and capture images, which can include following the processes discussed in FIGS. 8 and 12. The user can use a user interface such as, for example, a keyboard, mouse, touch screen, stylus, remote control device, etc. Software application 604 can include and/or work with a graphical user interface (GUI) as discussed herein. Once the drone 640 has been powered on in the desired environment, the user can select automatic mode on the drone 640 and/or in the software application 604, which causes the drone 640 automatically performs as discussed herein.

Photogrammetry is a technique to obtain reliable data of real-world objects in the environment by creating 3D models from photos. 2D and 3D data is extracted from an image, and with overlapping photos of an object, building, or terrain, converted into a digital 3D model. Photogrammetry is a technique for measuring objects using images, such as photographic images acquired by a digital camera for example. Photogrammetry can make 3D measurements from 2D images or photographs. When two or more images are acquired at different positions that have an overlapping field of view, common points or features may be identified on each image. By projecting a ray from the camera location to the feature/point on the object, the 3D coordinate of the feature/point may be determined using trigonometry or triangulation. In some examples, photogrammetry may be based on markers/targets (e.g., lights or reflective stickers) or based on natural features. To perform photogrammetry, for example, images are captured, such as with a camera (e.g., the camera 680) having a sensor, such as a photosensitive array for example. By acquiring multiple images of an object, or a portion of the object, from different positions or orientations, 3D coordinates of points on the object may be determined based on common features or points and information on the position and orientation of the camera when each image was acquired. In order to obtain the desired information for determining 3D coordinates, the features are identified in two or more images. Since the images are acquired from different positions or orientations, the common features are located in overlapping areas of the field of view of the images. It should be appreciated that photogrammetry techniques are described in commonly-owned U.S. Pat. No. 10,597,753, the contents of which are incorporated by reference herein. With photogrammetry, two or more images are captured and used to determine 3D coordinates of features.

The various components, modules, engines, etc. described regarding the computer system 602 and drone 640 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the computer system 602 for executing those instructions. Thus, a system memory (e.g., the memory 608) can store program instructions that when executed by the computer system 602 and the drone 640 implement the engines described herein. Other engines can also be utilized to include other features and functionality described in other examples herein.

A network adapter (not shown) allows the computer system 602 to transmit data to and/or receive data from other sources, such as other processing systems, data repositories, and the like. As an example, the computer system 602 can transmit data to and/or receive data from the drone 640 (including the camera 680, the scanner 670, and/or a user device coupled to the drone 640) directly and/or via a network 650. The network 650 represents any one or a combination of different types of suitable communications networks such as, for example, cable networks, public networks (e.g., the Internet), private networks, wireless networks, cellular networks, or any other suitable private and/or public networks. Further, the network 650 can have any suitable communication range associated therewith and may include, for example, global networks (e.g., the Internet), metropolitan area networks (MANs), wide area networks (WANs), local area networks (LANs), or personal area networks (PANs). In addition, the network 650 can include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

The camera 680 can be a 2D camera or a 3D camera (RGBD or time-of-flight for example). The camera 680 captures an image (or multiple images), such as of an environment 160. The camera 680 transmits the images to the computer system 602. In one or more embodiments, the camera 680 encrypts the image before transmitting it to the computer system 602. Although not shown, the camera 680 can include components such as a processing device, a memory, a network adapter, and the like, which may be functionally similar to those included in the computer system 500, 602 as described herein.

A coordinate measurement device, such as scanner 670 for example, is any suitable device for measuring 3D coordinates or points in an environment, such as the environment 160, to generate data about the environment. The scanner 670 may be implemented as a TOF laser scanner 20. A collection of 3D coordinate points is sometimes referred to as a point cloud. According to one or more embodiments described herein, the scanner 670 is a three-dimensional (3D) laser scanner time-of-flight (TOF) coordinate measurement device. It should be appreciated that while embodiments herein may refer to a laser scanner, this is for example purposes and the claims should not be so limited. In other embodiments, other types of coordinate measurement devices or combinations of coordinate measurement devices may be used, such as but not limited to triangulation scanners, structured light scanners, laser line probes, photogrammetry devices, and the like. A 3D TOF laser scanner steers a beam of light to a non-cooperative target such as a diffusely scattering surface of an object. A distance meter in the scanner 670 measures a distance to the object, and angular encoders measure the angles of rotation of two axles in the device. The measured distance and two angles enable a processor in the scanner 670 to determine the 3D coordinates of the target.

A TOF laser scanner, such as the scanner 670, is a scanner in which the distance to a target point is determined based on the speed of light in air between the scanner and a target point. Laser scanners are typically used for scanning closed or open spaces such as interior areas of buildings, industrial installations, and tunnels. They may be used, for example, in industrial applications and accident reconstruction applications. A laser scanner, such as the scanner 670, optically scans and measures objects in a volume around the scanner 670 through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected and stored as a point cloud, which can be transmitted to the computer system 602 and stored in the data 690 about the environment 160.

The camera 680 and/or scanner 670 are mounted to the drone 640. According to one or more embodiments described herein, the camera 680 captures 2D image(s) of the environment 160 and the scanner 670 captures 3D information of the environment 160. In some examples, the camera 680 and the scanner 670 are separate devices; however, in some examples, the camera 680 and the scanner 670 are integrated into a single device. For example, the camera 680 can include depth acquisition functionality and/or can be used in combination with a 3D acquisition depth camera, such as a time of flight camera, a stereo camera, a triangulation scanner, LIDAR, and the like. In some examples, 3D information can be measured/acquired/captured using a projected light pattern and a second camera (or the camera 680) using triangulation techniques for performing depth determinations. In some examples, a time-of-flight (TOF) approach can be used to enable intensity information (2D) and depth information (3D) to be acquired/captured. The camera 680 can be a stereo-camera to facilitate 3D acquisition. In some examples, a 2D image and 3D information (i.e., a 3D data set) can be captured/acquired at the same time; however, the 2D image and the 3D information can be obtained at different times.

In one or more embodiments, the computer system 602 may be a separate user device (e.g., a smartphone, a laptop or desktop computer, a tablet computer, a wearable computing device, a smart display, and the like) located within or proximate to the environment 160. The user device can display an image of the environment 160, such as on a display of the user device (e.g., the display 519 of the computer system 500 of FIG. 5) along with a digital visual element. In some examples, the user device can include components such as a processor, a memory, an input device (e.g., a touchscreen, a mouse, a microphone, etc.), an output device (e.g., a display, a speaker, etc.), and the like. In one or more embodiments, user device and computer system 602 can be utilized interchangeably.

For ease of understanding and not limitation, an example scenario is illustrated using drones to assist public safety professionals with automatically capturing images of a crash scene without requiring the user to understand the specifics of the process. An emergency scene is illustrated as a crash scene in FIG. 8. It should be appreciated that embodiments are not limited to the example scenario and other environments may be used.

FIG. 8 depicts a flowchart 800 for automatic drone data collection of an emergency scene (e.g., crash scene) according to one or more embodiments. A drone, such an unmanned or manned aerial vehicle, may include the camera 680 to capture aerial images of a physical location which can be the environment 160. The physical location can be a crash scene. Numerous images (e.g., typically several hundred images) may be captured in the first set of images and the second set of images discussed herein.

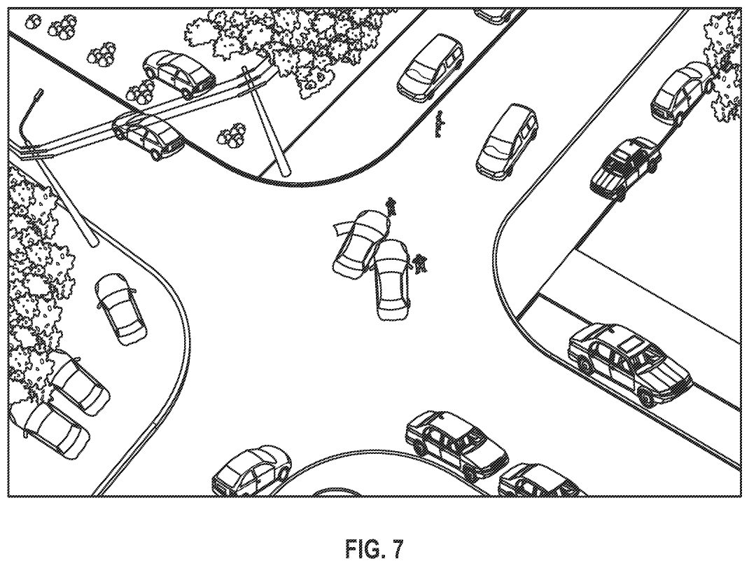

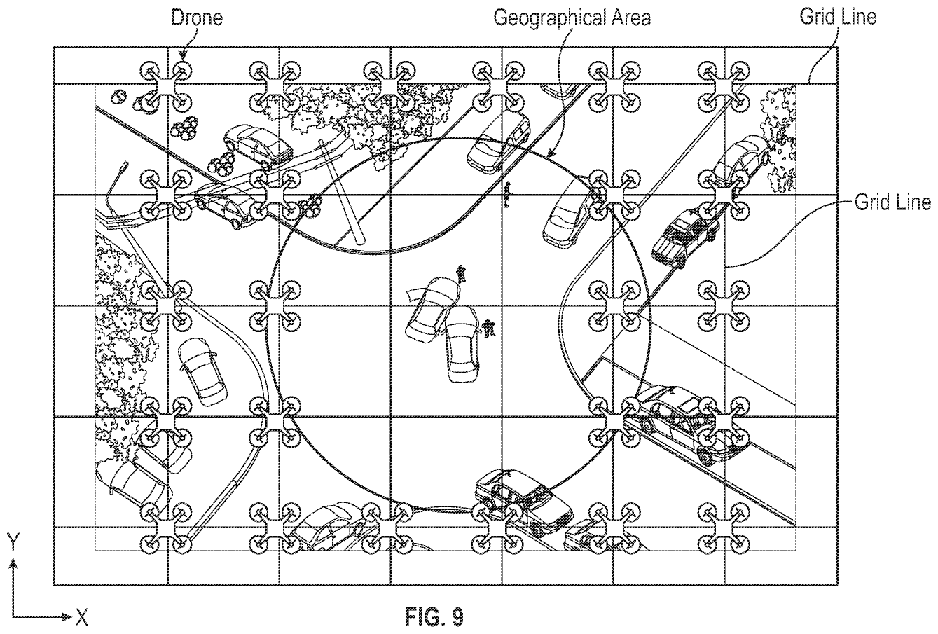

At block 802, the software application 604 is configured to cause and/or instruct the drone 640 to perform a detection routine for capturing a first set of images in the environment 160. The example environment 160 may be the crash scene depicted in FIG. 7. As such, the drone 640 is configured to acquire (record or capture) images temporarily while flying in a predesignated pattern in the environment 160. The predesignated pattern may be an array of grid lines (e.g., perpendicularly extending in an x and y direction) such that the grid lines overlap to form a grid, as depicted in FIG. 9. The drone 640 is automatically controlled to capture a first set of images temporarily stored as data 690. The drone 640 can automatically fly along a path following the x grid line, the y grid lines, and/or the both the x and y grid lines in order to capture images at each intersection in the grid, as depicted in FIG. 9. Although a rectangular or square grid is generally shown, embodiments are not meant to be limited. Other predesignated patterns can be utilized having a different geometric shape. Additionally, the drone 640 can be instructed to fly in any path that covers image acquisition in the predesignated pattern, and the drone 640 can fly a zigzag pattern, a spiral pattern, etc., in order to cover and scan the predesignated pattern (i.e., to cover the grid).

At block 804, the software application 604 is configured detect the emergency scene in the first set of images in data 690 of the environment 160. For example, the software application 604 is configured to detect the crash scene/site and/or accident by reviewing and identifying different objects in the first set of images of data 690. The software application 604 may employ rules-based algorithms for detecting the objects in the first set of images in data 690. In one or more embodiments, the software application 604 may employ and/or call a machine learning model 606 (e.g., an artificial neural network) that has been trained to detect the crash scene(s)/site(s) in the first set of images of data 690 for the environment 160. In some examples, there can be multiple vehicle crashes.

The determination to select images in the first set of images in data 690, which will be utilized to eventually identify locations for acquiring images of the emergency scene, can separate the first set of images in data 690 in categorizes. In one example, there can be two categories such as a first category that contains an object(s) associated with the crash scene/site and a second category that does not contain any object associated with the crash scene/site. If two categories are utilized as the output from the machine learning model 606, the software application 604 is configured to select images from the first category that contain an object associated with the crash scene/site as filtered images from the second set of images for further processing in block 806, while discarding images in the second category. The location data of each of the filtered images of the second set of images in data 690 is extracted along with the respective filtered image.

In one or more embodiments, the machine learning model 606 as well as the machine learning model 610 can include various engines/classifiers and/or can be implemented on a neural network. The features of the engines/classifiers can be implemented by configuring and arranging the computer system 602 to execute machine learning algorithms which form the machine leaning models. In general, machine learning algorithms, in effect, extract features from received data (e.g., inputs of (2D) images) in order to “classify” the received data. Examples of suitable classifiers include but are not limited to neural networks, support vector machines (SVMs), logistic regression, decision trees, hidden Markov Models (HMMs), etc. The end result of the classifier's operations, i.e., the “classification,” is to predict a class for the data. The machine learning algorithms apply machine learning techniques to the received data in order to, over time, create/train/update a unique “model.” The learning or training performed by the engines/classifiers can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, anomaly detection, neural networks, deep learning, and the like.

In one or more embodiments, the engines/classifiers are implemented as neural networks (or artificial neural networks), which use a connection (synapse) between a pre-neuron and a post-neuron, thus representing the connection weight. Neuromorphic systems are interconnected elements that act as simulated “neurons” and exchange “messages” between each other. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. After being weighted and transformed by a function (i.e., transfer function) determined by the network's designer, the activations of these input neurons are then passed to other downstream neurons, which are often referred to as “hidden” neurons. This process is repeated until an output neuron is activated. Thus, the activated output neuron determines (or “learns”) and provides an output or inference regarding the input.

Neural networks are usually created with base networks and based on requirements. Example base networks utilized may include RESNET50, RESNET 10, Xception, etc. It should be appreciated that other base networks could be utilized for images. After the creation of the neural network, the dataset (training and testing) is fed to the model with the specific loss function and the training is started. Training consists of different hyperparameters that need to be set in order to achieve better accuracy. The dataset that is fed into the deep learning model is processed, and this is called data preparation and augmentation.

For illustration and not limitation, the training datasets include aerial (2D) images of crash scenes. In some cases, pretrained or partially trained neural networks may be used which are further trained using the training datasets. The training datasets 607 may be utilized for training machine learning model 606 and training datasets 611 for machine learning model 610. Supervised learning was utilized in which the 2D images were manually segmented, classified/labeled (for respective objects of interest), and fed to the neural network.

The raw dataset is collected and sorted manually. The sorted dataset can be labeled/classified (e.g., using the Amazon Web Services® (AWS®) labeling tool). The labeling tool creates segmentation masks. Although additional labels can be used, a few examples of the labeling used in training the machine learning model 606 are discussed below and the labeling used for the machine learning model 610 are discussed later herein. With regard to the machine learning model 606, the neural network (or machine learning algorithms) is used to detect crash scenes/sites; particularly, the neural network is trained and configured to identify different objects in the training dataset 607 and eventually in the first set of image of data 690, where the objects are indicative of the crash scene/site in an environment. Objects labeled in training datasets 611 for machine learning model 610 may include some or all of the objects in images used to train machine learning model 606 along with other objects. For training machine learning model 606, examples of labeled objects in the images may include but are not limited to drivable roads, crash (1 car, 2 car, multiples cars), severity of accident, types of crash, skid marks, vehicle type, humans, bicycles, motor bicycle, location on the street, absolute location, buses, road markings, street signboards, roadside structures (poles, concrete walls, etc.), etc. In some cases, both the images and masks are sorted again in order to achieve data balancing and divided into training, testing, and validation datasets. Training and validation are used for training and evaluation, while testing is used after training to test the machine learning model on an unseen dataset. The training dataset may be processed through different data augmentation techniques. Training takes the labeled datasets, base networks, loss functions, and hyperparameters. Once these are all created and compiled, the training of the neural network occurs to eventually result in the trained machine learning model, such as trained machine learning model 606 and trained machine learning model 610. Once the model is trained, the model (including the adjusted weights) is saved to a file for deployment and/or further testing on the test dataset.

Referring to FIG. 8, at block 806, the software application 604 is configured to extract location data for the first set of images of data 690 that have been determined to cover the emergency scene in the environment 160 and then use the location data from the first set of images to calculate/determine the poses/locations for the drone 640. The poses of the drone 640 are the locations at which the drone 640 is to capture images in order to fully cover the emergency scene (i.e., the crash scene), without capturing unnecessary images. Each location (or pose) can be a waypoint along a path or route for the drone 640 to fly. As discussed herein, the machine learning model 606 was used to analyze the first set of images in data 690 which were initially captured for different accident scene objects like skid marks, car crash, car location, etc. Because the information about the location (including waypoints) at which each of the first set of images in data 690 were taken is already associated with each of the first set of images in data 690, software application 604 is configured make an estimation about the approximate location of different accident scene objects using their relative position in the first set of images in data 690. Once these approximate locations are determined, the software application 604 (via a network adapter (not shown)) is configured to send these locations (e.g., waypoints) to the drone 640, where if required an optimization routine (e.g., in the drone as understood by one or ordinary skill in the art) can determine the best flight path for the drone 640. The second set of images are to be acquired with more precise capture of the accident scene objects.

Waypoints are sets of coordinates that identify a point in physical space. Coordinates used can vary depending on the application. The coordinates can include longitude, latitude, and altitude, and even time. The waypoints can be used and determined in conjunction with a global positioning system (GPS). The locations for flying the drone 640 can utilize any navigation and guidance technology known by one of ordinary skill in the art. Location data is associated and stored with each image captured by the drone 640, and software application 604 is configured to form a mapping from the extracted location data to cover a geographical area of the emergency scene. As noted above, the location data can include waypoints at which each of the first set of images were captured, and the waypoints of all the images identified as being associated with the emergency scene (e.g., crash scene/site) are combined/correlated to form the overall geographical area encompassing the emergency scene. An example geographical area encompassing the emergency scene is depicted as a circle in FIG. 9.

At block 808, the software application 604 is configured to provide the locations/poses (and the overall geographical area) for capturing a second set of images to the drone 640. Although the determined geographical area is illustrated as a circle in FIG. 9, the geographical area around the emergency scene (e.g., crash scene/site) is not limited to a circle, and any geometric shape, such as a square, hexagon, etc., can be utilized to encompass the entirety of the emergency scene including any debris and skid marks associated with the accident. The drone 640 and the software application 604 may each have and/or utilize one or more drone application programming interfaces (APIs) or applications from a software development kit (SDK) for communicating the locations/poses at which the second set of images are to be captured within the geographical area of the emergency scene. The API and/or application (tool) from the SDK can be any suitable software for communications and instructions as known to one of ordinary skill in the art. In one or more embodiments, the software application 604 may transmit the locations/poses over the network 650 and/or via a connected cable. The computer system 602 executing software application 604 may be a user device. In one or more embodiments, the features of the computer system 602 may be included in the drone 640.

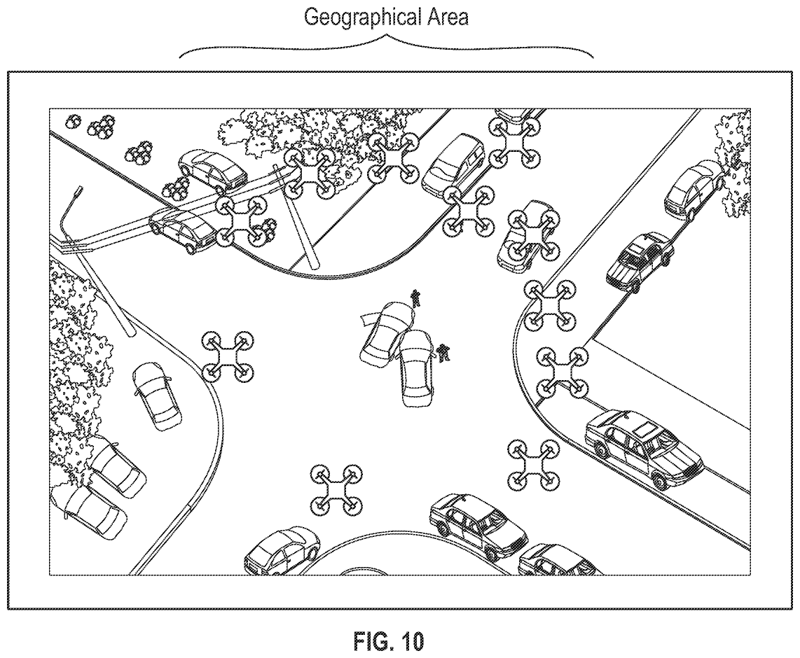

At block 810, the drone 640, as caused by the instructions (i.e., locations/poses) from the software application 604, is configured to fly to the locations/poses and capture images at each of the locations/poses within the geographical area, resulting in a second set of images permanently stored as data 692. FIG. 10 is an image depicting the drone 640 automatically capturing images of the emergency scene (e.g., the crash scene/site) for a circular geometric area according to one or more embodiments. FIG. 10 (along with FIG. 9) intentionally avoids showing the drone directly over the vehicles involved in the emergency so as not to obscure the figure, but it should be understood that locations/poses for acquiring images are directly over the vehicles as well.

The second set of images may be captured by the scanner 670, the camera 680, and/or both. The second set of images are captured with a higher resolution than the first set of images and may take more time than the quick scan performed to capture the first set of image in the date 690. The second set of images in data 692 may be captured with a narrower field of view than the first set of images in data 690, such that the second set of images in data 692 captures smaller/finer details in the emergency scene than the first set of images in data 690.

At block 812, the software application 604 is configured to automatically determine and select selected images 694 from the second set of images in data 692. The software application 604 is configured to parse the second set of images in data 692 and determine which images contain the most information (or most relevant information) about the emergency or incident. As such, a subset of the second set of images in data 692 contain the most information (or most relevant information) about the emergency or incident. The selected images 694 are automatically saved in a folder and presented to the safety professional (e.g., police officer). The selected images 694 may be graphically presented on a display (e.g., display 519). The selected images 694 may be used by other software (not shown) for further processing, such as photogrammetry software, to generate a 3D point cloud of the emergency scene in the environment 160.

The selected images 694 and other 2D images in data 692 may have been converted to orthoimages, orthophotos, or orthoimages. An orthophoto, orthophotograph, orthoimage, or orthoimagery is an aerial photograph or satellite imagery geometrically corrected (“orthorectified”) such that the scale is uniform: the photo or image follows a given map projection. Unlike an uncorrected aerial photograph, an orthophoto can be used to measure true distances, because it is an accurate representation of the earth's surface, having been adjusted for topographic relief, lens distortion, and camera tilt. Additionally, the images may be converted into orthoimages, using a suitable technique as understood by one of ordinary skill in the art. For accuracy and distance validation, various techniques can be used. An agency capturing aerial images can typically use the FARO® scalebar (for NIST traceability). This is an accurate way to verify distance measurement (of the drawing/sketch discussed herein) because it is based on software measurements and not the user. If a scalebar is not present, one can use a known measurement in their scene. Typically, a yard stick can be used or a tape measure at a known length can be used in the scene of the captured image. If a known measurement is not used, the user can utilize fixed points, such as the lane width or a door width of a vehicle.

The determination to select the selected images 694 may be rules-based algorithms and/or use a machine learning model 610. The rules-based algorithms and/or the machine learning model 610 may categorize the second set of images in data 692 in two categories such as a highest relevancy and a lowest relevancy, or three categories such as a highest relevancy, a middle relevancy, and a lower relevancy. As an example, if two categories are utilized as the output from the machine learning model 610 or rules-based algorithms, the software application 604 is configured to select images from the highest relevancy category as the selected images 694, while discarding the middle relevancy category. As an example, if three categories are utilized as the output from the rules-based algorithms and/or the machine learning model 610, the software application 604 is configured to select images from the highest relevancy and middle relevancy categories as the selected images 694, while discarding images in the lowest relevancy category. In one or more embodiments, the software application 604 (and/or software applications called by the software application 604) may check that there is sufficient overlap among selected images 694 in order to have common features for photogrammetry. If more images from the second set of images are needed, the software application 604 can select one or more additional images to provide sufficient overlap of common features with the previously selected images 694.

The machine learning model 610 can be an artificial neural network trained to detect images from the second set of images in data 692 which contribute most to the detection of the crash site by searching for certain objects. The machine learning model 610 is trained on numerous images containing these objects so as to detect these objects in the input images. The objects may be labeled during training, for example, in training datasets 611. Example objects that contribute to the crash scene/site include but are not limited to images containing damaged vehicles, skid marks, damaged objects, the location of the vehicles on the road, location of the vehicles off the road, wrong lane, wrong turn, etc. The training for machine learning model 610 is analogous to the training for machine learning model 606 discussed above, which results in the trained machine learning model 610.

Continuing the example scenario, whenever a crash happens on the road, the police officers are almost always moving as rapidly as possible to save every second so that reduce lost productivity, traffic, pollution, and secondary accidents. At the same time, police officers have to a ensure that they have gathered all the evidence they need before the roads are cleared of any debris and the damaged vehicles. With the advent of technology, the law enforcement officer can use a drone at a crash scene; however, the law enforcement officer is required to utilize manual steps with the drone, and there is no guarantee that the best possible data will be gathered. If there is some issue with data for scene reconstruction, it would be very difficult or impossible get the missing information, especially if the vehicles have been removed. Further, as described before, the law enforcement officer must still rely on drone to hopefully get the best possible images of the crash site and then sift through images (data) to get the most relevant images which can be used as evidence. However, this is all manual effort to create the final report and it is possible that drone image recording was not optimized. According to one or more embodiments discussed herein, the artificial intelligence neural network is trained to identify the accident scene. The neural network can then be used to identify the poses of the drone in order to obtain the most relevant images. Also, the neural network (and/or another neural network) can be trained to select the images which have the most information about the incident. These images can then be directly used for reporting and further image processing.

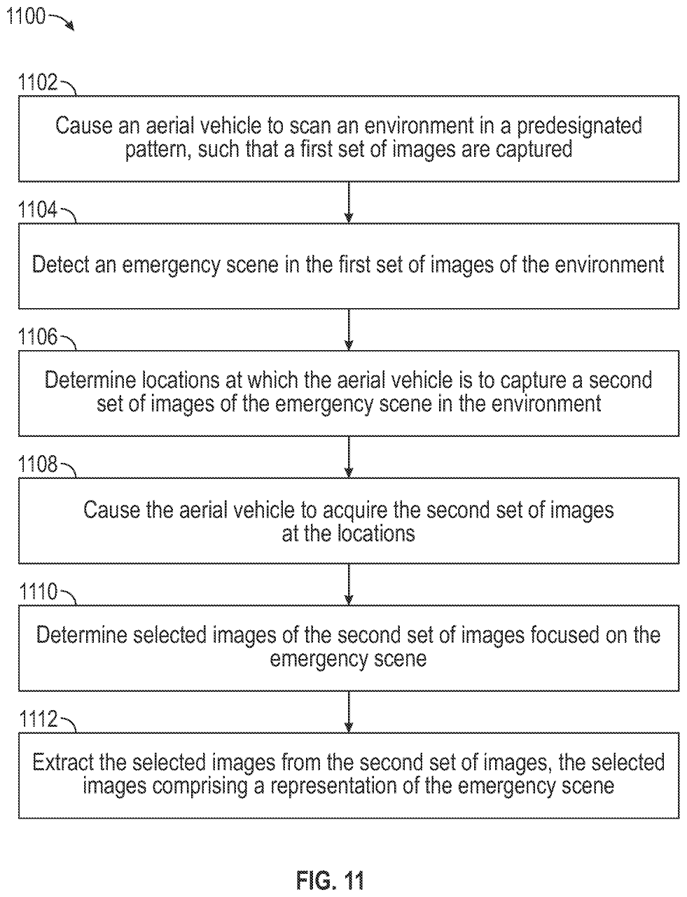

FIG. 11 depicts a flowchart of a computer-implemented method 1100 for drone data collection optimization for evidence recording at a crash scene/site according to one or more embodiments described herein. The computer-implemented method 800 can be performed by or implemented on any suitable processing system, for example, the computer system 602 in FIG. 6, a cloud computing node, and/or combinations thereof in conjunction with a drone such as drone 640. As noted herein, the software application 604 may call and/or employ various software such as the machine learning model 606, the machine leaning model 610, the API/SDK, the GUI, photogrammetry software, etc., in order to perform the computer-implemented method 800 in accordance with the one or more embodiments, although each piece of software may not be explicitly

At block 1102 of the computer-implemented method 1100, the software application 604 is configured to cause an aerial vehicle (e.g., drone 640) to scan an environment 160 in a predesignated pattern (e.g., a grid pattern, zigzag pattern, spiral pattern, etc.,), such that a first set of images are captured (e.g., data 690). At block 1104, the software application 604 is configured to detect an emergency scene (e.g., a crash scene/site) in the first set of images of the environment 160. At block 1106, the software application 604 is configured to determine locations (e.g., poses) at which the aerial vehicle (e.g., done 640) is to capture a second set of images of the emergency scene in the environment 160. At block 1108, the software application 604 is configured to cause the aerial vehicle to acquire the second set of images (e.g., data 692) at the locations (e.g., locations substantially in and/or about geographical area of the crash scene/site depicted in FIGS. 10 and 11). At block 1110, the software application 604 is configured to determine selected images 694 of the second set of images (e.g., data 692) focused on the emergency scene. At block 1112, the software application 604 is configured to extract the selected images 694 from the second set of images (e.g., data 692), the selected images 694 comprising a representation of the emergency scene. The combination of the selected images 694 are a representation of the crash scene in the geographical area.

The second set of images (e.g., data 692) comprises a higher resolution than the first set of images (e.g., data 690). The locations form a geographical area (e.g., depicted in FIGS. 10 and 11) less than the predesignated pattern (e.g., the example predesignated grid pattern in FIG. 9) such that the locations are narrowed to a view of the emergency scene.

A machine learning model 606 is used to detect the emergency scene in the first set of images of the environment, the machine learning model 606 is trained to detect objects associated with the emergency scene in the first set of images and infer that the emergency scene is present in the environment 160. Coordinates (e.g., waypoints) of a geographical area comprising the emergency scene are determined; determining the locations at which the aerial vehicle (e.g., drone 640) is to capture the second set of images of the emergency scene in the environment comprises using one or more of the coordinates (e.g., waypoints) as the locations at which to capture the second set of images.

A machine learning model 610 is trained to determine the selected images 694 of the second set of images focused on the emergency scene. The machine learning model 610 is configured to find objects in the selected images 694 that are associated with the reconstruction of an emergency of the emergency scene. The emergency scene is a crash scene. The locations are transmitted to the aerial vehicle (e.g., drone 640) at which to acquire the second set of images at the locations.

While embodiments of the invention have been described in detail in connection with only a limited number of embodiments, it should be readily understood that embodiments of the invention are not limited to such disclosed embodiments. Rather, embodiments of the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, embodiments of the invention are not to be seen as limited by the foregoing description, but is only limited by the scope of the appended claims.

What is claimed is:

1. A computer-implemented method comprising:
causing an aerial vehicle to scan an environment in a predesignated pattern, such that a first set of images are captured;
detecting an emergency scene in the first set of images of the environment;
determining locations at which the aerial vehicle is to capture a second set of images of the emergency scene in the environment;
causing the aerial vehicle to acquire the second set of images at the locations;
determining selected images of the second set of images focused on the emergency scene; and
extracting the selected images from the second set of images, the selected images comprising a representation of the emergency scene.

2. The computer-implemented method of claim 1, wherein the second set of images comprises a higher resolution than the first set of images.

3. The computer-implemented method of claim 1, wherein the locations form a geographical area less than the predesignated pattern such that the locations are narrowed to a view of the emergency scene.

4. The computer-implemented method of claim 1, wherein a machine learning model is used to detect the emergency scene in the first set of images of the environment, the machine learning model is trained to detect objects associated with the emergency scene in the first set of images and infer that the emergency scene is present in the environment.

5. The computer-implemented method of claim 4, wherein:
coordinates of a geographical area comprising the emergency scene are determined; and
determining the locations at which the aerial vehicle is to capture the second set of images of the emergency scene in the environment comprises using one or more of the coordinates as the locations at which to capture the second set of images.

6. The computer-implemented method of claim 1, wherein a machine learning model is trained to determine the selected images of the second set of images focused on the emergency scene.

7. The computer-implemented method of claim 6, wherein the machine learning model is configured to find objects in the selected images that are associated with a reconstruction of an emergency of the emergency scene.

8. The computer-implemented method of claim 1, wherein the emergency scene is an accident scene.

9. The computer-implemented method of claim 1, wherein the locations are transmitted to the aerial vehicle at which to acquire the second set of images at the locations.

10. A system comprising:
a memory having computer readable instructions; and
one or more processors for executing the computer readable instructions, the computer readable instructions controlling the one or more processors to perform operations comprising:
causing an aerial vehicle to scan an environment in a predesignated pattern, such that a first set of images are captured;
detecting an emergency scene in the first set of images of the environment;
determining locations at which the aerial vehicle is to capture a second set of images of the emergency scene in the environment;
causing the aerial vehicle to acquire the second set of images at the locations;
determining selected images of the second set of images focused on the emergency scene; and
extracting the selected images from the second set of images, the selected images comprising a representation of the emergency scene.

11. The system of claim 10, wherein the second set of images comprises a higher resolution than the first set of images.

12. The system of claim 10, wherein the locations form a geographical area less than the predesignated pattern such that the locations are narrowed to a view of the emergency scene.

13. The system of claim 10, wherein a machine learning model is used to detect the emergency scene in the first set of images of the environment, the machine learning model is trained to detect objects associated with the emergency scene in the first set of images and infer that the emergency scene is present in the environment.

14. The system of claim 13, wherein:
coordinates of a geographical area comprising the emergency scene are determined; and
determining the locations at which the aerial vehicle is to capture the second set of images of the emergency scene in the environment comprises using one or more of the coordinates as the locations at which to capture the second set of images.

15. The system of claim 10, wherein a machine learning model is trained to determine the selected images of the second set of images focused on the emergency scene.

16. The system of claim 15, wherein the machine learning model is configured to find objects in the selected images that are associated with a reconstruction of an emergency of the emergency scene.

17. The system of claim 10, wherein the emergency scene is an accident scene.

18. The system of claim 10, wherein the locations are transmitted to the aerial vehicle at which to acquire the second set of images at the locations.

19. A computer program product comprising a computer readable storage medium having program instructions embodied therewith, the program instructions executable by one or more processors to cause the one or more processors to perform operations comprising:
causing an aerial vehicle to scan an environment in a predesignated pattern, such that a first set of images are captured;
detecting an emergency scene in the first set of images of the environment;
determining locations at which the aerial vehicle is to capture a second set of images of the emergency scene in the environment;
causing the aerial vehicle to acquire the second set of images at the locations;
determining selected images of the second set of images focused on the emergency scene; and
extracting the selected images from the second set of images, the selected images comprising a representation of the emergency scene.

20. The computer program product of claim 19, wherein the second set of images comprises a higher resolution than the first set of images.
